(19) United States
(12) Patent Application Publication
(10) Pub. No.: US 2026/0018338 A1
(43) Pub. Date: Jan. 15, 2026

(54) MULTI-LAYERED CAPACITOR AND METHOD FOR MANUFACTURING SAME

(71) Applicants: SAMSUNG ELECTRO-MECHANICS CO., LTD., Suwon-si (KR); INDUSTRY-UNIVERSITY COOPERATION FOUNDATION KOREA AEROSPACE UNIVERSITY, Goyang-si (KR)

(72) Inventors: Jooyoung Kim, Suwon-si (KR); Do-Kyun Kwon, Seoul (KR); Jaehoon Ji, Suwon-si (KR); Eunyoung Lee, Suwon-si (KR)

(73) Assignees: SAMSUNG ELECTRO-MECHANICS CO., LTD., Suwon-si (KR); INDUSTRY-UNIVERSITY COOPERATION FOUNDATION KOREA AEROSPACE UNIVERSITY, Goyang-si (KR)

(21) Appl. No.: 19/012,717

(22) Filed: Jan. 7, 2025

(30) Foreign Application Priority Data
Jul. 15, 2024 (KR) 10-2024-0093088

(51) Int. Cl. H01G 4/12; H01G 4/30

(52) U.S. Cl. CPC H01G 4/1227; H01G 4/30

(57) ABSTRACT

A multi-layered capacitor including a capacitor body including a dielectric layer and an internal electrode; and an external electrode disposed on an outer side of the capacitor body, wherein the dielectric layer includes a plurality of dielectric crystal grains, and the dielectric crystal grains include a core containing BaTiO₃, a first shell disposed on the core and containing BaTiO₃ doped with a first doping element of Sr, Ca, Bi, K, Na, or a combination thereof, and a second shell disposed on the first shell and containing a first coating element of Nb, Ta, or a combination thereof.

### CROSS-REFERENCE TO RELATED APPLICATION

This application claims priority to and the benefit of Korean Patent Application No. 10-2024-0093088 filed in the Korean Intellectual Property Office on Jul. 15, 2024, the entire contents of which are incorporated herein by reference.

### BACKGROUND

### (a) Technical Field

The present disclosure relates to a multi-layered capacitor and a method for manufacturing the same.

### (b) Description of the Related Art

Downsizing of multi-layered ceramic capacitors (MLCCs) is also essential in line with the industry trend to reduce the final package size. In addition, in response to the recent trend of requiring both miniaturization and high capacitance of MLCCs, many related companies and research institutes are focusing on a fundamental modification of BaTiO₃ dielectric material, which is a base material, in order to achieve the goals of ultra-miniaturization and high capacitance at the same time.

Furthermore, as the demand for MLCCs for automotive electronics is also rapidly increasing along with the growth of the electric vehicle market, it is necessary to secure the development technology for dielectric ceramics with excellent temperature stability, which is an essential requirement for MLCCs for automotive electronics.

On the other hand, in terms of structure, MLCC can be broadly divided into a body portion where multiple layers of dielectric and internal electrode single layers are stacked together, and an outer electrode portion that connects the multilayer internal electrodes simultaneously. In this case, to achieve the high capacitance of the MLCC, the number of layers in the body portion should be increased. However, this makes it challenging to simultaneously achieve high capacitance and size miniaturization of the MLCC.

To solve this problem, it is necessary to improve high dielectric constant, thinning, and temperature stability of the dielectric material that implements the capacitance of the MLCC.

The technologies of the related art approach to increase the crystallinity of BaTiO₃ or develop other novel compositions in order to achieve high dielectric constant and thinning of the dielectric material, but have limitation in implementing high dielectric constant due to the difficulty in controlling the microstructure during the sintering process. In addition, the research on adding dopants in order to improve temperature stability has improved the temperature stability but has a challenge in securing high dielectric constant at the same time.

### SUMMARY

Accordingly, the present disclosure attempts to provide a multi-layered capacitor that enables thinning by reducing the size of dielectric crystal grains in a dielectric layer and can achieve high temperature stability and high dielectric constant at the same time.

An embodiment of the present disclosure provides a multi-layered capacitor including a capacitor body including a dielectric layer and an internal electrode; and an external electrode disposed on an outer side of the capacitor body, wherein the dielectric layer includes a plurality of dielectric crystal grains, and the plurality of dielectric crystal grains include a core including BaTiO₃, a first shell disposed on the core and including BaTiO₃ doped with a first doping element selected from Sr, Ca, Bi, K, Na, or a combination thereof, and a second shell disposed on the first shell and including a first coating element selected from Nb, Ta, or a combination thereof.

When line analysis is performed on the plurality of dielectric crystal grains using transmission electron microscopy-energy dispersive X-ray (TEM-EDX) analysis, a maximum peak of a concentration of the first doping element may appear in a region of the first shell, and a maximum peak of a concentration of the first coating element may appear in a region of the second shell.

When line analysis is performed on the plurality of dielectric crystal grains using TEM-EDX analysis, a lowest value of a concentration of the first doping element may appear in a region of the core.

When line analysis is performed on the plurality of dielectric crystal grains using TEM-EDX analysis, a lowest value of a concentration of the first coating element may appear in a region of the core.

A content of the first doping element in the plurality of dielectric crystal grains may be 4 to 21 mol % based on a total number of moles of Ti in the plurality of dielectric crystal grains.

A content of the first coating element in the plurality of dielectric crystal grains may be 1 to 5 mol % based on a total number of moles of Ti in the plurality of dielectric crystal grains.

The first shell may further contain a second doping element selected from Ti, Hf, Zr, Mg, Nb, Ta, or a combination thereof.

The second shell may further contain a second coating element selected from Sr, Ca, or a combination thereof.

A content of the second coating element in the plurality of dielectric crystal grains may be 0.8 to 3.2 mol % based on a total number of moles of Ti in the plurality of dielectric crystal grains.

The first shell comprises a compound represented by Chemical Formula 1 below.

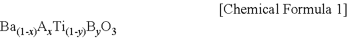

In Chemical Formula 1, A is Sr, Ca, Bi, K, Na, or a combination thereof, B is Ti, Hf, Zr, Mg, Nb, Ta, or a combination thereof, and 0<x≤0.3 and 0≤y≤0.3.

The second shell may include X₂Nb₃O₁₀, X₂Ta₃O₁₀, X₂Nb₂O₇, X₂Ta₂O₇, XBi₂Nb₂O₉, XBi₂Ta₂O₉, or a combination thereof, in which X may be Sr, Ca, or a combination thereof.

An average crystal grain size of the plurality of dielectric crystal grains may be 600 nm or less.

Another embodiment of the present disclosure provides a method of manufacturing a multi-layered capacitor, the method including: manufacturing a dielectric powder; manufacturing a dielectric green sheet from the dielectric powder; forming a conductive paste layer on a surface of the dielectric green sheet; manufacturing a dielectric green sheet laminate by stacking a plurality of the dielectric green sheets, each of which has the conductive paste layer formed thereon; firing the dielectric green sheet laminate to manufacture a capacitor body including a dielectric layer and an internal electrode; and forming an external electrode on one surface of the capacitor body, wherein the dielectric layer includes a plurality of dielectric crystal grains, and the plurality of dielectric crystal grains include a core including BaTiO₃, a first shell disposed on the core and including BaTiO₃ doped with a first doping element selected from Sr, Ca, Bi, K, Na, or a combination thereof, and a second shell disposed on the first shell and including a first coating element selected from Nb, Ta, or a combination thereof.

The manufacturing of the dielectric powder may include mixing BaTiO₃, a first doping raw material, and a solvent to form a first mixture; heat-treating the mixture, and then washing and drying the mixture to form BaTiO₃ doped with the first doping element; forming a nanosheet including a first coating element; and grinding and mixing the BaTiO₃ doped with the first doping element and the nanosheet to form a dielectric crystal grain, wherein the first doping raw material may be a Sr raw material, a Ca raw material, a Bi raw material, a K raw material, a Na raw material, or a combination thereof.

The forming of the nanosheet may include mixing a first coating raw material and K₂CO₃ to form a second mixture, and then firing the second mixture to form a first intermediate material with a first multilayer structure; treating the first intermediate material with an acid to form a second intermediate material with a second multilayer structure, wherein the second intermediate material includes hydrogen; and putting the second intermediate material into a basic solvent, followed by stirring and ultrasonic treatment, to remove hydrogen from the second intermediate material, to exfoliate the second intermediate material, and to form a nanosheet with a single layer structure from which hydrogen has been removed, wherein the first coating raw material may be a Nb raw material, a Ta raw material, or a combination thereof.

The basic solvent may be tetrabutylammonium hydroxide (TBAOH), tetramethylammonium hydroxide (TMAOH), or a combination thereof.

The grinding and mixing may include wet grinding and mixing.

A thickness of the nanosheet may be 3.5 nm or less.

The firing of the second mixture may be performed at 700° C. to 1300° C.

The mixing of the first coating raw material and K₂CO₃ includes mixing a second coating raw material, the first coating raw material, and K₂CO₃, and in this case, the second coating raw material may be a Sr raw material, a Ca raw material, or a combination thereof.

In the multi-layered capacitor according to an embodiment of the present disclosure, the dielectric crystal grains in the dielectric layer include the core, the first shell, and the second shell having different compositions, making it possible to reduce the size of the dielectric crystal grains, thereby enabling thinning of the dielectric layer, and at the same time, improving the temperature stability and dielectric constant of the dielectric layer.

### BRIEF DESCRIPTION OF THE DRAWINGS

FIG. 1 is a perspective view showing a multi-layered capacitor according to an embodiment of the present disclosure.

FIG. 2 is a cross-sectional view of the multi-layered capacitor taken along line I-l′ of FIG. 1.

FIG. 3 is an exploded perspective view showing a stacked structure of internal electrodes in a capacitor body of FIG. 1.

FIG. 4 is a conceptual view of a dielectric crystal grain according to an embodiment of the present disclosure.

FIG. 5 is a schematic diagram showing a method for manufacturing dielectric crystal grains according to an embodiment of the present disclosure.

FIGS. 6 and 7A to 7C are TEM-EDX line scan analysis images and graphs of dielectric crystal grains in a multi-layered capacitor prepared according to Example 4.

FIGS. 8 to 10 are TEM-EDX elemental mapping analysis images of dielectric crystal grains in the multi-layered capacitor prepared according to Example 4.

FIGS. 11 to 13 are TEM-EDX elemental mapping analysis images of dielectric crystal grains of a comparative group of Experimental Example 1.

FIG. 14 is a graph showing an evaluation result of temperature stability of a dielectric material according to Experimental Example 2.

### DETAILED DESCRIPTION

In the following detailed description, only certain embodiments of the present disclosure have been shown and described, simply by way of illustration. The drawings and description are to be regarded as illustrative in nature and not restrictive. Like reference numerals designate like elements throughout the specification. Further, the accompanying drawings are provided for helping to easily understand embodiments disclosed in the present specification, and the technical spirit disclosed in the present specification is not limited by the accompanying drawings, and it will be appreciated that the present disclosure includes all of the modifications, equivalent matters, and substitutes included in the spirit and the technical scope of the present disclosure.

Terms including an ordinary number, such as first and second, are used for describing various constituent elements, but the constituent elements are not limited by the terms. The terms are used only to discriminate one constituent element from another constituent element.

When it is mentioned that a certain constituent element is “connected” or “coupled” to another constituent element, it should be understood that the certain constituent element may be directly connected or coupled to or face the other constituent element or another intervening constituent element may be located therebetween. Conversely, when it is mentioned that a certain constituent element is “directly connected” or “directly coupled” to another constituent element, it should be understood that there is no intervening constituent element present.

In the present application, it will be appreciated that terms “including” and “having” are intended to designate the existence of characteristics, numbers, steps, operations, constituent elements, and components described in the specification or a combination thereof, and do not exclude a possibility of the existence or addition of one or more other characteristics, numbers, steps, operations, constituent elements, and components, or a combination thereof in advance. Therefore, unless explicitly described to the contrary, the word “comprise”, and variations such as “comprises” or “comprising”, will be understood to imply the inclusion of stated elements but not the exclusion of any other elements.

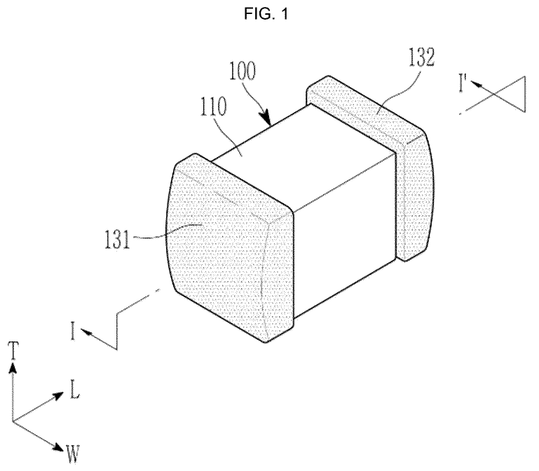

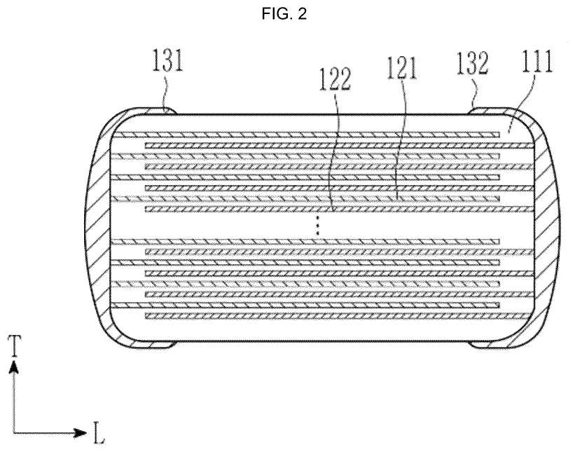

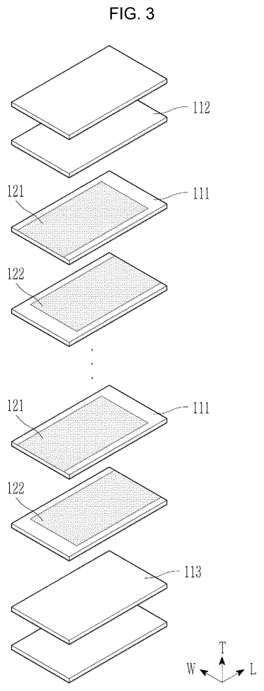

FIG. 1 is a perspective view showing a multi-layered capacitor 100 according to an embodiment of the present disclosure, FIG. 2 is a cross-sectional view of the multi-layered capacitor 100 taken along line I-I′ of FIG. 1, and FIG. 3 is an exploded perspective view showing a stacked structure of internal electrodes in a capacitor body 110 of FIG. 1.

When directions are defined in order to clearly describe the present embodiment, an L-axis, a W-axis, and a T-axis shown in the drawing indicate a length direction, a width direction, and a thickness direction of the capacitor body 110, respectively. Here, the thickness direction (T-axis direction) may be a direction perpendicular to a wide surface (main surface) of sheet-shaped components, and may be used as the same concept as the stacking direction in which a dielectric layer 111 is stacked, for example. The length direction (L-axis direction) may be a direction that extends parallel to the wide surface (main surface) of the sheet-shaped components and is approximately perpendicular to the thickness direction (T-axis direction), and may be, for example, a direction in which a first external electrode 131 and a second external electrode 132 are located on both sides. The width direction (W-axis direction) may be a direction that extends parallel to the wide surface (main surface) of the sheet-shaped components and is approximately perpendicular to the thickness direction (T-axis direction) and the length direction (L-axis direction), and a length in the length direction (L-axis direction) of the sheet-shaped components may be longer than a length in the width direction (W-axis direction).

Referring to FIGS. 1 to 3, a multi-layered capacitor 100 according to the present embodiment may include a capacitor body 110, and a first external electrode 131 and a second external electrode 132 disposed at opposite ends in the length direction (L-axis direction) of the capacitor body 110.

The capacitor body 110 may have, for example, a substantially hexahedral shape.

In the present embodiment, for convenience of description, two surfaces facing each other in the thickness direction (T-axis direction) of the capacitor body 110 are defined as a first surface and a second surface, two surfaces connected to the first surface and the second surface and facing each other in the length direction (L-axis direction) are defined as a third surface and a fourth surface, and two surfaces connected to the first surface and the second surface, connected to the third surface and the fourth surface, and facing each other in the width direction (W-axis direction) are defined as a fifth surface and a sixth surface.

For example, the first surface, which is a lower surface, may be a surface facing a mounting direction. In addition, the first to sixth surfaces may be flat, but the present embodiment is not limited thereto, and for example, the first to sixth surfaces may be curved surfaces with a convex central portion, and corners, which are boundaries of respective surfaces, may be rounded.

The shape and dimension of the capacitor body 110 and the number of stacked dielectric layers 111 are not limited to those shown in the drawings of the present embodiment.

The capacitor body 110 is formed by stacking a plurality of dielectric layers 111 in the thickness direction (T-axis direction) and then firing them, and includes a plurality of dielectric layers 111 and first internal electrodes 121 and second internal electrodes 122 alternately disposed in the thickness direction (T-axis direction) with the respective dielectric layers 111 interposed therebetween.

In this case, the boundary between the respective dielectric layers 111 adjacent to each other of the capacitor body 110 may be integrated to the extent that it is difficult to check the boundary without using a scanning electron microscope (SEM).

Additionally, the capacitor body 110 may include an active region and cover regions 112 and 113.

The active region is a part contributing to generating capacitance of the multi-layered capacitor 100. For example, the active region may be a region where the first internal electrode 121 or the second internal electrode 122 stacked along the thickness direction (T-axis direction) overlaps.

The cover regions 112 and 113 are margin portions in the thickness direction and may be respectively disposed on the first surface and second surface sides of the active region in the thickness direction (T-axis direction). The cover regions 112 and 113 may be formed by stacking a single dielectric layer 111 or two or more dielectric layers 111 on an upper surface and a lower surface of the active region, respectively.

Additionally, the capacitor body 110 may further include a side cover region. The side cover region is a margin portion in the width direction and may be respectively disposed on the fifth surface and the sixth surface of the active region in the width direction (W-axis direction). Such a side cover region may be formed by stacking dielectric green sheets where, when applying a conductive paste layer for forming an internal electrode on a surface of a dielectric green sheet, the conductive paste layer is applied to only a portion of the surface of the dielectric green sheet and the conductive paste layer is not applied to both side surfaces of the dielectric green sheet, and then firing the sheets.

The cover regions 112 and 113 and the side cover region serve to prevent damage to the first internal electrode 121 and the second internal electrode 122 due to physical or chemical stress.

Below, the dielectric crystal grains according to an embodiment of the present disclosure will be described in more detail.

The dielectric layer 111 according to an embodiment of the present disclosure includes a plurality of dielectric crystal grains 1111.

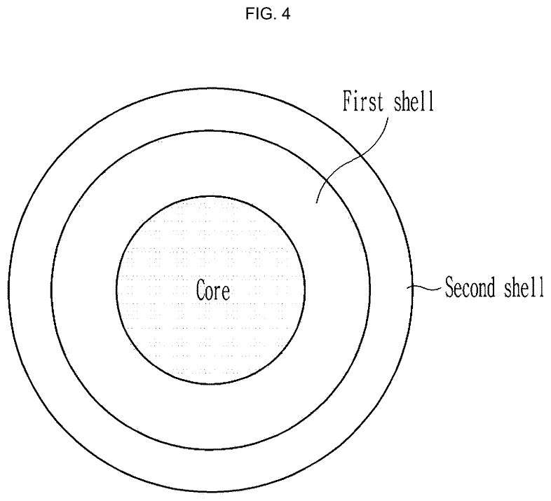

FIG. 4 is a conceptual view of a dielectric crystal grain according to an embodiment of the present disclosure.

Referring to FIG. 4, the dielectric crystal grain according to an embodiment of the present disclosure includes a core containing BaTiO₃, a first shell disposed on the core and containing BaTiO₃ doped with a first doping element, and a second shell disposed on the first shell and containing a first coating element.

That is, the dielectric crystal grain according to an embodiment of the present disclosure has a sequentially stacked structure including a core, a first shell, and a second shell having different compositions. This makes it possible to reduce the size of the dielectric crystal grains, thereby enabling thinning of the dielectric layer, and at the same time, improving the temperature stability and dielectric constant of the dielectric layer.

More specifically, the core contains BaTiO₃ as a main component.

In addition, the first shell contains BaTiO₃ doped with a first doping element of Sr, Ca, Bi, K, Na, or a combination thereof.

Additionally, the second shell contains a first coating element of Nb, Ta, or a combination thereof.

In this case, the different compositional aspects of the dielectric crystal grain, the core, the first shell, and the second shell can be confirmed through transmission electron microscopy-energy dispersive X-ray (TEM-EDX) analysis. Other methods and/or tools appreciated by one of ordinary skill in the art, even if not described in the present disclosure, may also be used.

Specifically, when line analysis is performed on the dielectric crystal grains using TEM-EDX analysis, a maximum peak of a concentration of the first doping element may appear in a region of the first shell. Additionally, a maximum peak of a concentration of the first coating element may appear in a region of the second shell. That is, the first doping element can form the highest concentration in the region of the first shell of the entire region of the core, the first shell, and the second shell. Additionally, the second doping element can form the highest concentration in the region of the second shell of the entire region of the core, the first shell, and the second shell.

In addition, when line analysis is performed on the dielectric crystal grains using TEM-EDX analysis, a lowest value of the concentration of the first doping element may appear in a region of the core. That is, the first doping element can form the lowest concentration in the core region of the entire region of the core, the first shell, and the second shell.

When line analysis is performed on the dielectric crystal grains using TEM-EDX, a lowest value of the concentration of the first coating element may appear in the region of the core. That is, the first coating element can form the lowest concentration in the core region of the entire region of the core, the first shell, and the second shell.

In this way, since the first doping element and the first coating element show a distinct concentration gradient aspect in the core-the first shell-the second shell, the performance improvement effect of the multi-layered capacitor described above can be more preferably implemented.

Note that, as described below, such a distinct concentration gradient aspect can be achieved by first coating BaTiO₃ with the first doping element and then manufacturing and coating a nanosheet containing the first coating element. A more detailed description thereof will be given in the manufacturing method described below.

A content of the first doping element in the dielectric crystal grains may be 4 to 21 mol %, and more specifically, 4.5 to 20.5 mol % based on a total number of moles of Ti in the dielectric crystal grains. If the content of the first doping element is too low, there may be a problem in that the Tc (Curie temperature) shift characteristic to room temperature is not sufficiently exhibited. If the content of the first doping element is too high, the paraelectric characteristic may become more pronounced, leading to a decrease in dielectric constant.

A content of the first coating element in the dielectric crystal grains may be 1 to 5 mol %, and more specifically, 1.3 to 4.7 mol % based on the total number of moles of Ti in the dielectric crystal grains. If the content of the first coating element is too low, there may be a problem in that the temperature stability effect is not exhibited. If the content of the first coating element is too high, the shell fraction in the crystal grains may be increased during sintering, leading to a decrease in dielectric constant.

Note that the first shell may further contain a second doping element of Ti, Hf, Zr, Mg, Nb, Ta, or a combination thereof.

Additionally, the second shell may further contain a second coating element of Sr, Ca, or a combination thereof.

In this case, a content of the second coating element in the dielectric crystal grains may be 0.8 to 3.2 mol %, and more specifically, 0.9 to 3.1 mol % based on the total number of moles of Ti in the dielectric crystal grains. If the content of the second coating element is too low, there may be a problem in that the Tc shift characteristic to room temperature is not sufficiently exhibited. If the content of the second coating element is too high, the paraelectric characteristic may become more pronounced, leading to a decrease in dielectric constant.

More specifically, the first shell may include a compound represented by Chemical Formula 1 below.

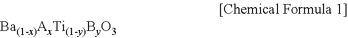

In Chemical Formula 1, A is Sr, Ca, Bi, K, Na, or a combination thereof, B is Ti, Hf, Zr, Mg, Nb, Ta or a combination thereof, and 0<x≤0.3 and 0≤y≤0.3.

In addition, the second shell may include X₂Nb₃O₁₀, X₂Ta₃O₁₀, X₂Nb₂O₇, X₂Ta₂O₇, XBi₂Nb₂O₉, XBi₂Ta₂O₉, or a combination thereof, in which X may be Sr, Ca, or a combination thereof.

Additionally, a diameter of the core may be about 15 to 25 nm. If the core diameter is too small, the dielectric constant may be reduced. If the core diameter is too large, the relative proportion of the shell decreases, which may lead to a reduction in reliability.

A thickness of the first shell may be about 30 to 70 nm. If the thickness of the first shell is too small, the relative proportion of the shell decreases, which may lead to a reduction in reliability. If the thickness of the first shell is too large, the paraelectric characteristic may become more pronounced, leading to a decrease in dielectric constant.

A thickness of the second shell may be about 2 to 5 nm. If the thickness of the second shell is too small, there may be a problem in that the flattening effect of TCC (temperature coefficient of capacitance) curve may not be achieved due to the reduced content of the first coating element. If the thickness of the second shell is too large, the dielectric constant may be decreased due to the increased content of the first coating element.

Note that since the dielectric crystal grains according to an embodiment of the present disclosure form the structure of the core, the first shell, and the second shell described above, an average crystal grain size can be effectively reduced, such that the size may be 600 nm or less, and more specifically, 500 nm, 400 nm, 300 nm, 250 nm, or 220 nm or less. In the present specification, the average crystal grain size of the dielectric crystal grains may be measured under a voltage condition of 200 keV with field emission transmission electron microscope (FE-TEM) after preparing a specimen from a sintered body using focused ion beam (FIB). Other methods and/or tools appreciated by one of ordinary skill in the art, even if not described in the present disclosure, may also be used.

As an example, an average thickness of the dielectric layer 111 may be 0.5 μm to 10 μm.

Note that the first internal electrode 121 and the second internal electrode 122 are electrodes with different polarities and are alternately disposed to face each other along the T-axis direction with the dielectric layers 111 interposed therebetween, and one end of the first internal electrode and one end of the second internal electrode may be exposed through the third and fourth surfaces of the capacitor body 110, respectively.

The first internal electrode 121 and the second internal electrode 122 can be electrically insulated from each other by the dielectric layer 111 disposed therebetween.

The end portions of the first internal electrodes 121 and the second internal electrodes 122, which are alternately exposed through the third and fourth surfaces of the capacitor body 110, can be electrically connected to the first external electrode 131 and the second external electrode 132, respectively.

The first internal electrode 121 and the second internal electrode 122 include a conductive metal, for example, a metal such as Ni, Cu, Ag, Pd, or Au, or an alloy thereof, for example, an Ag—Pd alloy.

Additionally, the first internal electrode 121 and the second internal electrode 122 may include dielectric particles having the same composition system as a ceramic material included in the dielectric layer 111.

The first internal electrode 121 and the second internal electrode 122 may be formed using a conductive paste including a conductive metal. For a method for printing the conductive paste, a screen printing method, a gravure printing method, or the like may be used.

For example, an average thickness of the first internal electrode 121 and the second internal electrode 122 may be 0.1 μm to 2 μm.

The first external electrode 131 and the second external electrode 132 are supplied with voltages of different polarities and can be electrically connected to the exposed portions of the first internal electrodes 121 and the second internal electrodes 122, respectively.

According to the configuration, when a predetermined voltage is applied to the first external electrode 131 and the second external electrode 132, charges are accumulated between the first internal electrode 121 and the second internal electrode 122 facing each other. In this case, the electrostatic capacitance of the multi-layered capacitor 100 becomes proportional to an overlapping area of the first internal electrode 121 and the second internal electrode 122 overlapping each other along the T-axis direction in the active region.

The first external electrode 131 and the second external electrode 132 may include first and second connection portions respectively disposed on the third and fourth surfaces of the capacitor body 110 and connected to the first internal electrode 121 and the second internal electrode 122, and first and second band portions respectively disposed at corners where the third and fourth surfaces of the capacitor body 110 and the first and second surfaces or the fifth and sixth surfaces meet.

The first and second band portions may extend from the first and second connection portions to portions of the first and second surfaces or the fifth and sixth surfaces of the capacitor body 110, respectively. The first and second band portions can serve to improve the adhesion strength of the first external electrode 131 and the second external electrode 132.

For example, the first external electrode 131 and the second external electrode 132 may each include a sintered metal layer in contact with the capacitor body 110, a conductive resin layer disposed to cover the sintered metal layer, and a plating layer disposed to cover the conductive resin layer.

The sintered metal layer may include a conductive metal and glass.

For example, the sintered metal layer may include a conductive metal such as copper (Cu), nickel (Ni), silver (Ag), palladium (Pd), gold (Au), platinum (Pt), tin (Sn), tungsten (W), titanium (Ti), lead (Pb), an alloy thereof, or a combination thereof, in which for example, copper (Cu) may include a copper (Cu) alloy. When the conductive metal includes copper, a metal other than copper may be contained in an amount of 5 mole parts or less per 100 mole parts of copper.

For example, the sintered metal layer may include a mixed composition of oxides as glass, for example, one or more selected from the group consisting of silicon oxide, boron oxide, aluminum oxide, transition metal oxide, alkali metal oxide, and alkaline earth metal oxide. The transition metal may be selected from the group consisting of zinc (Zn), titanium (Ti), copper (Cu), vanadium (V), manganese (Mn), iron (Fe), and nickel (Ni), the alkali metal may be selected from the group consisting of lithium (Li), sodium (Na), and potassium (K), and the alkaline earth metal may be at least one selected from the group consisting of magnesium (Mg), calcium (Ca), strontium (Sr), and barium (Ba).

A content of the conductive metal and glass in the sintered metal layer is not particularly limited, but, for example, an average area of the conductive metal in a cross-section (cross-section in the L-axis direction and the T-axis direction) perpendicular to the thickness direction (W-axis direction) of the multi-layered capacitor 100 may be 30% to 90%, or 70% to 90%, of a total area of the sintered metal layer.

Optionally, the conductive resin layer is formed on the sintered metal layer, and may be formed, for example, in a form of completely covering the sintered metal layer. Note that the first external electrode 131 and the second external electrode 132 may not include the sintered metal layer, and in this case, the conductive resin layer may be in direct contact with the capacitor body 110.

The conductive resin layer may extend to the first and second surfaces or the fifth and sixth surfaces of the capacitor body 110, and a length of the region (i.e., the band portion) in which the conductive resin layer extends to the first and second surfaces or the fifth and sixth surfaces of the capacitor body 110 and is disposed may be longer than a length of the region (i.e., the band portion) in which the sintered metal layer extends to the first and second surfaces or the fifth and sixth surfaces of the capacitor body 110 and is disposed. That is, the conductive resin layer is formed on the sintered metal layer and may be formed in a form of completely covering the sintered metal layer.

The conductive resin layer includes a resin and a conductive metal.

The resin included in the conductive resin layer is not particularly limited as long as it has adhesion and shock absorption properties and can be mixed with conductive metal powder to form a paste, and may include, for example, phenol resin, acrylic resin, silicone resin, epoxy resin, or polyimide resin.

The conductive metal included in the conductive resin layer serves to electrically connect the conductive resin layer to the first internal electrode 121 and the second internal electrode 122 or the sintered metal layer.

The conductive metal included in the conductive resin layer may have a spherical shape, a flake shape, or a combination thereof. That is, the conductive metal may have only a flake shape or only a spherical shape, or may be in a mixed form of flake and spherical shapes.

Here, the spherical shape may also include a shape that is not a perfect sphere, for example, a shape having a length ratio of a major axis to a minor axis (major axis/minor axis) of 1.45 or less. Flake-shaped powder refers to a powder having a flat and elongated shape, and is not particularly limited, but for example, the length ratio of the major axis to the minor axis (major axis/minor axis) may be 1.95 or greater.

The first external electrode 131 and the second external electrode 132 may further include a plating layer disposed on an outer side of the conductive resin layer.

The plating layer may include nickel (Ni), copper (Cu), tin (Sn), palladium (Pd), platinum (Pt), gold (Au), silver (Ag), tungsten (W), titanium (Ti), or lead (Pb), alone or an alloy thereof. For example, the plating layer may be a nickel (Ni) plating layer or a tin (Sn) plating layer, and may be in a form in which a nickel (Ni) plating layer and a tin (Sn) plating layer are sequentially stacked, or may be in a form in which a tin (Sn) plating layer, a nickel (Ni) plating layer, and a tin (Sn) plating layer are sequentially stacked. Additionally, the plating layer may include a plurality of nickel (Ni) plating layers and/or a plurality of tin (Sn) plating layers.

The plating layer can improve mountability with a substrate, structural reliability, durability against external impact, heat resistance, and equivalent series resistance (ESR) of the multi-layered capacitor 100.

A method for manufacturing a multi-layered capacitor according to another embodiment of the present disclosure will be described.

Another embodiment of the present disclosure provides a method for manufacturing a multi-layered capacitor, the method including the steps of: manufacturing a dielectric powder; manufacturing a dielectric green sheet using the dielectric powder, and forming a conductive paste layer on a surface of the dielectric green sheet; manufacturing a dielectric green sheet laminate by stacking the dielectric green sheets, each of which has the conductive paste layer formed thereon; firing the dielectric green sheet laminate to manufacture a capacitor body including a dielectric layer and an internal electrode; and forming an external electrode on one surface of the capacitor body, wherein the dielectric layer includes a plurality of dielectric crystal grains, and the dielectric crystal grains include a core containing BaTiO₃, a first shell disposed on the core and containing BaTiO₃ doped with a first doping element of Sr, Ca, Bi, K, Na, or a combination thereof, and a second shell disposed on the first shell and containing a first coating element of Nb, Ta, or a combination thereof.

Below, the method for manufacturing a multi-layered capacitor according to an embodiment of the present disclosure will be described in detail step by step.

First, a dielectric powder is manufactured.

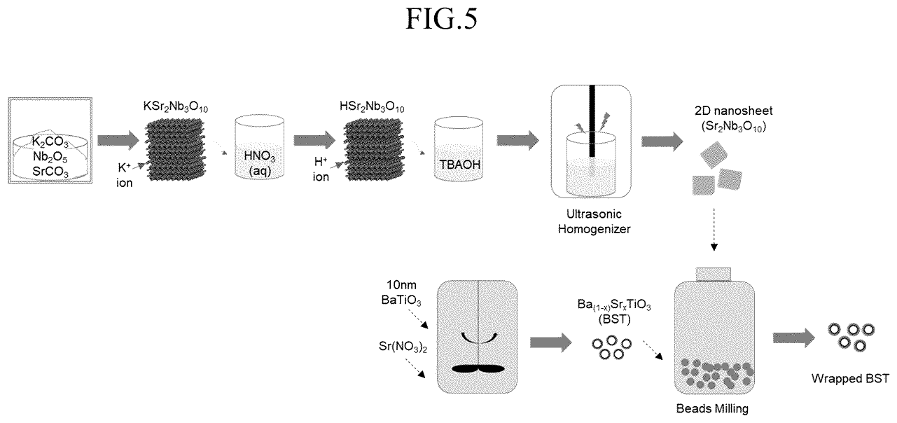

FIG. 5 is a schematic diagram showing a method for manufacturing dielectric powder according to an embodiment of the present disclosure. Note that FIG. 5 only shows an example of a dielectric powder according to an embodiment of the present disclosure, and the scope of the present disclosure is not limited to the manufacturing method of FIG. 5.

Referring to FIG. 5, the step of manufacturing the dielectric powder includes steps of mixing BaTiO₃, a first doping raw material, and a solvent to form a mixture; heat-treating the mixture, and then washing and drying the mixture to form BaTiO₃ doped with a first doping element; forming a nanosheet containing a first coating element; and grinding and mixing BaTiO₃ doped with the first doping element and the nanosheet to form a dielectric crystal grain.

First, BaTiO₃, a first doping raw material and a solvent are mixed to form a mixture.

The BaTiO₃ is not particularly limited as long as an average particle diameter (D50) is 5 to 15 nm. If the average particle diameter (D50) of BaTiO₃ is too small, a size of the core in the final dielectric powder is small, which may result in a decrease in dielectric constant. If the average particle diameter (D50) of BaTiO₃ is too large, an average particle size of the finished dielectric particles may increase or coarse particles may be generated.

Note that, in the present specification, the average particle diameter (D50) may be defined as a particle diameter corresponding to 50% of the cumulative volume in the particle diameter distribution curve of particles. The average particle diameter (D50) may be measured using, for example, a laser diffraction method. In the laser diffraction method, in general, particle diameters ranging from a submicron region to several millimeters can be measured, and results with high reproducibility and high resolvability can be obtained.

The first doping raw material may be a Sr raw material, a Ca raw material, a Bi raw material, a K raw material, a Na raw material, or a combination thereof.

The Sr raw material may be, for example, Sr(NO₃)₂, SrCO₃, or a combination thereof.

The Ca raw material may be, for example, Ca(NO₃)₂, CaCO₃, or a combination thereof.

The Bi raw material may be, for example, Bi(NO₃)₃·5H₂O, Bi₅O(OH)₉(NO₃)₄, or a combination thereof.

The K raw material may be, for example, K₂CO₃, KOH, KNO₃, or a combination thereof.

The Na raw material may be, for example, NaNO₃, Na₂CO₃, NaOH, or a combination thereof.

The solvent may be water, ethanol, toluene, or a combination thereof.

Next, the mixture is heat treated, and then washed and dried to form BaTiO₃ doped with the first doping element.

The heat treatment may be performed at a temperature of 200° C. to 300° C., and more specifically, at a temperature of 220° C. to 300° C. If the heat treatment temperature is too low, there may be problems such as a failure to achieve the target particle size or a reduction in crystallinity. If the heat treatment temperature is too high, there may be problems such as increased internal particle defects or excessive particle growth.

The heat treatment may be performed at a pressure of 40 to 50 bar. If the pressure is too low during heat treatment, there may be a problem of a reduction in crystallinity of particles. If the pressure is too high during heat treatment, there may be a problem of reduced particle uniformity due to a low reaction concentration.

The heat treatment may be performed for 30 minutes to 72 hours. When the heat treatment time satisfies the range, BaTiO₃ doped with the first doping element and having a size within an appropriate range can be obtained.

BaTiO₃ doped with the first doping element formed accordingly may have the average particle diameter (D50) of 90 to 120 nm.

Next, a nanosheet containing a first coating element is formed.

The step of forming the nanosheet may include, more specifically, steps of mixing a first coating raw material and K₂CO₃ and then firing the mixture to form a first intermediate material with a multilayer structure; treating the first intermediate material with an acid to form a hydrogen-containing second intermediate material with a multilayer structure; and putting the second intermediate material into a basic solvent, followed by stirring and ultrasonic treatment, to exfoliate the second intermediate material and form a nanosheet with a single layer structure from which hydrogen has been removed.

First, a first coating raw material and K₂CO₃ are mixed, and then the mixture is fired to from a first intermediate material with a multilayer structure.

The first coating raw material may be a Nb raw material, a Ta raw material, or a combination thereof.

The Nb raw material may be, for example, Nb₂O₅, ammonium niobate(V) oxalate hydrate, or a combination thereof.

The Ta raw material may be, for example, Ta₂O₅.

In this case, a second coating raw material may be further mixed, and the second coating raw material may be a Sr raw material, a Ca raw material, or a combination thereof.

The Sr raw material may be, for example, SrCO₃, Sr(NO₃)₂, or a combination thereof.

The Ca raw material may be, for example, CaCO₃, Ca(NO₃)₂, or a combination thereof.

The firing may be performed at a temperature of 700° C. to 1300° C., and more specifically, at a temperature of 900° C. to 1100° C. If the firing temperature is too low, unreacted products may remain, leading to formation of a secondary phase or a decrease in yield. If the firing temperature is too high, volatilization of the K component is accelerated, causing the stoichiometry of the final product to be disrupted, which can lead to defects.

The firing may be performed for 3 to 9 hours, and more specifically, 5 to 7 hours. If the firing time is too short, there may be problems such as a low conversion of raw materials or formation of a secondary phase. If the firing time is too long, the size of the product may increase, leading to deterioration in efficiency of exfoliation or wrapping process.

Next, the first intermediate material is treated with an acid to form a hydrogen-containing second intermediate material with a multilayer structure.

The acid treatment may be performed by putting the first intermediate material into an acid solution and stirring the resultant solution.

In this case, the acid solution may be, for example, a nitric acid aqueous solution, a hydrochloric acid aqueous solution, or a sulfuric acid aqueous solution.

A concentration of the acid solution may be 4 to 7 M.

The stirring may be performed for 48 to 96 hours, and more specifically, 60 to 84 hours.

Next, the second intermediate material is put into a basic solvent, followed by stirring and ultrasonic treatment, to exfoliate the second intermediate material and form a nanosheet with a single layer structure from which hydrogen has been removed.

With this, a nanosheet with a single layer structure, which is a final product, can be formed.

The basic solvent may be tetrabutylammonium hydroxide (TBAOH), tetramethylammonium hydroxide (TMAOH), or a combination thereof.

The ultrasonic treatment may be performed, for example, by an ultrasonic homogenizer process.

A thickness of the nanosheet formed through this may be 3.5 nm or less, and more specifically, 3.2 nm. If the thickness of the nanosheet is too thick, wrapping may not proceed smoothly, which may lead to a decrease in coating efficiency and variations in content of the coating raw materials in the final product. The thickness of the nanosheet may be determined by TEM. Other methods and/or tools appreciated by one of ordinary skill in the art, even if not described in the present disclosure, may also be used.

Next, BaTiO₃ doped with the first doping element and the nanosheet are ground and mixed to form dielectric crystal grains.

Thus, the first coating element (or the first coating element and the second coating element) in the nanosheet can be wrapped (coated) on the surface of BaTiO₃ doped with the first doping element.

The grinding and mixing may be performed by a wet grinding and mixing method. Compared to the dry grinding and mixing method, performing the wet grinding and mixing method can offer advantages such as better physical contact between raw materials, leading to higher mixing and wrapping (coating) efficiency.

The wet grinding and mixing may be performed by a method common in the art, but may be performed by a wet grinding process method, for example, through a bead mill process.

For example, during a wrapping process using a bead mill method, a ratio of the doping element of BaTiO₃ particles doped with the first doping element and a ratio of the first coating element in the nanosheet are designed to match target values. The solvent may be water, ethanol, or the like, and the dielectric crystal grains may be finally obtained by milling at a stirring speed of about 100 to 150 rpm for approximately 10 to 40 hours, followed by drying the internal slurry.

With this, the dielectric crystal grains according to an embodiment of the present disclosure can be finally obtained.

Next, the manufacturing of the capacitor body will be described.

In the manufacturing process of the capacitor body, a dielectric paste that becomes a dielectric layer after firing and a conductive paste that becomes an internal electrode after firing are prepared.

The dielectric paste is manufactured by, for example, the following method. The manufactured hafnium (Hf)-doped dielectric powder is uniformly mixed using a method such as wet mixing, dried, and then heat-treated under predetermined conditions to obtain calcined powder. An organic vehicle or an aqueous vehicle is added to the obtained calcined powder, which is then kneaded to prepare a dielectric paste.

The obtained dielectric paste is formed into a sheet using a technique such as a doctor blade method, thereby producing a dielectric green sheet. Additionally, the dielectric paste may contain additives selected from various dispersants, plasticizers, dielectrics, minor component compounds, or glass, as needed.

The conductive paste for an internal electrode is prepared by kneading conductive powder made of a conductive metal or an alloy thereof with a binder or solvent. The conductive paste for an internal electrode may contain ceramic powder (e.g., barium titanate powder) as a co-material, as needed. The co-material may serve to inhibit sintering of the conductive powder during the sintering process.

The conductive paste for an internal electrode is applied in a predetermined pattern on the surface of the dielectric green sheet by using various printing methods such as screen printing or a transfer method. Then, multiple layers of dielectric green sheets having internal electrode patterns formed thereon are stacked and then pressed in a stacking direction to obtain a dielectric green sheet laminate. In this case, the dielectric green sheets and the internal electrode patterns may be stacked such that the dielectric green sheets are located on the upper and lower surfaces of the dielectric green sheet laminate in the stacking direction.

Optionally, the obtained dielectric green sheet laminate may be cut into a predetermined size by dicing or the like.

In addition, the dielectric green sheet laminate may be solidified and dried to remove plasticizers and the like, as needed, and may be subjected to barrel polishing using a horizontal centrifugal barrel machine or the like after solidified and dried. In the barrel polishing, the dielectric green sheet laminate may be put into a barrel container together with a medium and a polishing liquid, and the barrel container may be applied with rotational motion or vibration, resulting in polishing of unnecessary parts such as burrs generated during cutting. Additionally, after barrel polishing, the dielectric green sheet laminate may be washed with a cleaning solution such as water and dried.

The dielectric green sheet laminate is subjected to binder removing and firing treatments to obtain a capacitor body.

The conditions for the binder removing treatment may be appropriately adjusted depending on the main component composition of the dielectric layer or the main component composition of the internal electrode. For example, a temperature increase rate during the binder removing treatment may be 5° C./hour to 300° C./hour, a support temperature may be 180° C. to 400° C., and a temperature holding time may be 0.5 hour to 24 hours. The binder removing atmosphere can be air or a reducing atmosphere.

The conditions of the sintering treatment may be appropriately adjusted depending on the main component composition of the dielectric layer or the main component composition of the internal electrode. For example, the temperature during firing may be 1200° C. to 1350° C., or 1220° C. to 1300° C., and the time may be 0.5 hour to 8 hours, or 1 hour to 3 hours. The firing atmosphere may be a reducing atmosphere, for example, a humidified atmosphere of a mixed gas of nitrogen gas (N₂) and hydrogen gas (H₂). When the internal electrode contains nickel (Ni) or nickel (Ni) alloy, an oxygen partial pressure in the sintering atmosphere is 1.0×10⁻¹⁴ MPa to 1.0×10⁻¹⁰ MPa.

After the sintering treatment, annealing may be performed as needed. Annealing is a treatment to re-oxidize the dielectric layer, and annealing may be performed when the firing treatment is performed in a reducing atmosphere. The conditions for annealing treatment may also be appropriately adjusted depending on the main component composition of the dielectric layer. For example, the temperature during annealing may be 950° C. to 1150° C., the time may be 0 hour to 20 hours, and the temperature increase rate may be 50° C./hour to 500° C./hour. The annealing atmosphere may be a humidified nitrogen gas (N₂) atmosphere, and the oxygen partial pressure may be 1.0×10⁻⁹ MPa to 1.0×10⁻⁵ MPa.

In the binder removing treatment, the firing treatment, or the annealing treatment, for example, a wetter may be used to humidify a nitrogen gas or a mixed gas, and in this case, the water temperature may be 5° C. to 75° C. The binder removing treatment, the firing treatment, and the annealing treatment may be performed consecutively or independently.

Optionally, a surface treatment such as sandblasting, laser irradiation, or barrel polishing may be performed on the third and fourth surfaces of the obtained capacitor body. By performing such a surface treatment, the end portions of the first internal electrode and the second internal electrode can be exposed on the outermost surfaces of the third and fourth surfaces, thereby facilitating a favorable electrical connection between the first external electrode and second external electrode and the first internal electrode and second internal electrode and making it easier for an alloy portion to be formed.

A paste for forming a sintered metal layer as an external electrode may be applied to an outer surface of the obtained capacitor body and then sintered to form a sintered metal layer.

The paste for forming a sintered metal layer may include a conductive metal and glass. The description of the conductive metal and glass is the same as the above description, so a redundant description will be omitted. Additionally, the paste for forming a sintered metal layer may optionally include a minor component such as a binder, a solvent, a dispersant, a plasticizer, or an oxide powder. For example, the binder may be ethyl cellulose, acrylic, or butyral, and the solvent may be an organic solvent such as terpineol, butyl carbitol, alcohol, methyl ethyl ketone, acetone, or toluene, or an aqueous solvent.

A method for applying the paste for forming a sintered metal layer to the outer surface of the capacitor body may include ae dip method, various printing methods such as a screen printing, an applying method using, for example, a dispenser, or a spraying method using a spray. The paste for a sintered metal layer may be applied to at least the third and fourth surfaces of the capacitor body, and optionally to a portion of the first surface, the second surface, the fifth surface, or the sixth surface where the band portions of the first external electrode and the second external electrode are formed.

Thereafter, the capacitor body to which the paste for forming a sintered metal layer has been applied is dried, and sintered at a temperature of 700° C. to 1000° C. for 0.1 hour to 3 hours to form a sintered metal layer.

Optionally, a paste for forming a conductive resin layer may be applied to the outer surface of the obtained capacitor body and then cured to form a conductive resin layer.

The paste for forming a conductive resin layer may include a resin and optionally a conductive metal or a non-conductive filler. The description of the conductive metal and resin is the same as the above description, so a redundant description will be omitted. Additionally, the paste for forming a conductive resin layer may optionally include a minor component such as a binder, a solvent, a dispersant, a plasticizer, or an oxide powder. For example, the binder may be ethyl cellulose, acrylic, or butyral, and the solvent may be an organic solvent such as terpineol, butyl carbitol, alcohol, methyl ethyl ketone, acetone, or toluene, or an aqueous solvent.

For example, a method for forming a conductive resin layer may include dipping the capacitor body 110 in a paste for forming a conductive resin layer and then curing it, printing a paste for forming a conductive resin layer on a surface of the capacitor body 110 using a screen printing method or a gravure printing method, or applying a paste for forming a conductive resin layer on a surface of the capacitor body 110 and then curing it.

Next, a plating layer is formed on an outer side of the conductive resin layer.

For example, the plating layer may be formed by a plating method, a sputtering method or an electric deposition method.

The following Examples illustrate the present embodiments in more detail. However, the following Examples are only preferred examples of the present disclosure, and the present disclosure is not by limited by the following Examples.

### Example 1

### (1) Preparing of Dielectric Crystal Grains

### (Preparing of Sr-Doped BaTiO₃)

First, BaTiO₃ fine particles with an average particle diameter (D50) of about 10 nm, which had been pre-prepared, and Sr(NO₃)₂ of a target content were weighed and put into a closed batch reactor, followed by addition of pure water to form a mixture. Then, the mixture was heat-treated under conditions of 260° C. and 46 bar for 6 hours to prepare Sr-doped BaTiO₃ with an average particle diameter (D50) of about 75±5 nm. In this case, the content of doped Sr (first doping element) was 5 mol % based on the total number of moles of Ti.

### (Preparing of Nanosheet)

First, K₂CO₃, Nb₂O₅ as the first coating raw material, SrCO₃ as the second coating raw material were weighed according to their stoichiometric ratios and fired at 1000° C. for 6 hours to form KSr₂Nb₃O₁₀, the first intermediate material with a multilayer structure. Then, the first intermediate material was put into a 6M nitric acid aqueous solution and stirred for about 72 hours so that the K atoms were replaced with H atoms, thereby forming HSr₂Nb₃O₁₀, the H-containing second intermediate material with a multilayer structure. Then, to remove the interlayer hydrogen atom layer and exfoliate the second intermediate material into a single layer, the second intermediate material was put into a TBAOH (Tetrabutylammonium hydroxide), followed by application of ultrasonic energy using an ultrasonic homogenizer to increase stirring and exfoliation efficiency. This resulted in Sr₂Nb₃O₁₀, a 2D nanosheet with a thickness of 2 to 3 nm, which was a final product. In this case, the content of Nb (the first coating element) in the nanosheet was 3 mol % based on the total number of moles of Ti, and the content of Sr (the second coating element) in the nanosheet was 2 mol % based on the total number of moles of Ti.

### (Preparing of Dielectric Crystal Grains (Nanosheet Wrapping))

The prepared Sr-doped BaTiO₃ and the 2D nanosheets were mixed, then ground and mixed through a wet bead mill process, followed by drying to finally prepare dielectric crystal grains wrapped with nanosheets.

### (2) Preparing of Multi-Layered Capacitor

The dielectric crystal grains as a dielectric base material, ethanol/toluene, a dispersant, and a binder were mixed and then mechanically milled to prepare a dielectric slurry.

Then, the prepared dielectric slurry was used to prepare a dielectric green sheet by using an on-roll molding coater of a head discharge type.

Then, a conductive paste layer containing nickel (Ni) was printed on the surface of the dielectric green sheet, and the dielectric green sheets having the conductive paste layer formed thereon (width×length×height=3.2 mm×2.5 mm×2.5 mm) were stacked and pressed to prepare a dielectric green sheet laminate.

Then, the dielectric green sheet laminate was calcined at a temperature of 400° C. or lower in a nitrogen atmosphere, followed by firing under conditions of a firing temperature of 1300° C. or lower and a hydrogen concentration of 1.0% H₂ to prepare a capacitor body. Then, an external electrode was formed on the outer side of the capacitor body to prepare a multi-layered capacitor.

### Examples 2 to 5

Dielectric crystal grains and multi-layered capacitors were prepared in the same manner as in Example 1, except that in the preparing step of Sr-doped BaTiO₃, the content of doped Sr (first doping element) was varied as shown in Table 1 below, and in the preparing step of nanosheet, the content of Nb (first coating element) in the nanosheet and the content of Sr (second coating element) in the nanosheet were varied as shown in Table 1 below.

### Example 6

### (1) Preparing of Dielectric Crystal Grains

### (Preparing of Sr-Doped BaTiO₃)

First, BaTiO₃ fine particles with an average particle diameter (D50) of about 10 nm, and Sr(NO₃)₂ of a target content were weighed and put into a closed batch reactor, followed by addition of pure water to form a mixture. Then, the mixture was heat-treated under conditions of 260° C. and 46 bar for 6 hours to prepare Sr-doped BaTiO₃ with an average particle diameter (D50) of about 75±5 nm. In this case, the content of doped Sr (first doping element) was 5 mol % based on the total number of moles of Ba.

### (Preparing of Nanosheet)

First, K₂CO₃, Nb₂O₅ as the first coating raw material, CaCO₃ as the second coating raw material were weighed according to their stoichiometric ratios and fired at 1000° C. for 6 hours to form KCa₂Nb₃O₁₀, the first intermediate material with a multilayer structure. Then, the first intermediate material was put into a 6M nitric acid aqueous solution and stirred for about 72 hours so that the K atoms were replaced with H atoms, thereby forming HCa₂Nb₃O₁₀, the H-containing second intermediate material with a multilayer structure. Then, to remove the interlayer hydrogen atom layer and exfoliate the second intermediate material into a single layer, the second intermediate material was put into a TBAOH (Tetrabutylammonium hydroxide), followed by application of ultrasonic energy using an ultrasonic homogenizer to increase stirring and exfoliation efficiency. This resulted in Ca₂Nb₃O₁₀, a 2D nanosheet with a thickness of 2 to 3 nm, which was a final product. In this case, the content of Nb (the first coating element) in the nanosheet was 3 mol % based on the total number of moles of Ti, and the content of Ca (the second coating element) in the nanosheet was 2 mol % based on the total number of moles of Ti.

### (Preparing of Dielectric Crystal Grains)

The prepared Sr-doped BaTiO₃ and the 2D nanosheets were mixed, then ground through a bead mill process, followed by drying to finally prepare dielectric crystal grains wrapped with nanosheets.

### (2) Preparing of Multi-Layered Capacitor

The dielectric crystal grains as a dielectric base material, ethanol/toluene, a dispersant, and a binder were mixed and then mechanically milled to prepare a dielectric slurry.

Then, the prepared dielectric slurry was used to prepare a dielectric green sheet by using an on-roll molding coater of a head discharge type.

Then, a conductive paste layer containing nickel (Ni) was printed on the surface of the dielectric green sheet, and the dielectric green sheets having the conductive paste layer formed thereon (width×length×height=3.2 mm×2.5 mm×2.5 mm) were stacked and pressed to prepare a dielectric green sheet laminate.

Then, the dielectric green sheet laminate was calcined at a temperature of 400° C. or lower in a nitrogen atmosphere, followed by firing under conditions of a firing temperature of 1300° C. or lower and a hydrogen concentration of 1.0% H₂ to prepare a capacitor body. Then, an external electrode was formed on the outer side of the capacitor body to prepare a multi-layered capacitor.

### Examples 7 and 8

Dielectric crystal grains and multi-layered capacitors were prepared in the same manner as in Example 6, except that in the preparing step of Sr-doped BaTiO₃, the content of doped Sr (first doping element) was varied as shown in Table 1 below, and in the preparing step of nanosheet, the content of Nb (first coating element) in the nanosheet and the content of Ca (second coating element) in the nanosheet were varied as shown in Table 1 below.

### Comparative Examples 1 to 4

Dielectric crystal grains and multi-layered capacitors were prepared in the same manner as in Example 1, except that in the preparing step of Sr-doped BaTiO₃, the content of doped Sr (first doping element) was varied as shown in Table 1 below to prepare only Sr-doped BaTiO₃, and the preparing of nanosheet and the wrapping, which were subsequent steps, were not performed.

### Comparative Example 5

Dielectric crystal grains and a multi-layered capacitor were prepared in the same manner as in Example 1, except that a pure BaTiO₃ base material without Sr doping was used.

### Comparative Example 6

Dielectric crystal grains and a multi-layered capacitor were prepared in the same manner as in Example 6, except that a pure BaTiO₃ base material without Sr doping was used.

Table 1 below summarizes the dielectric crystal grain compositions of the Examples and the Comparative Examples.

TABLE 1

| | | | | | | | | Ratio of |
|---|---|---|---|---|---|---|---|---|
| | | | | | | | | second shell |
| | | | | | Content | Content | Content | thickness |
| | | | | | of first | of first | of second | (relative to |
| | | | | | doping | coating | coating | core radius |
| | | First | First | Second | element | element | element | and first |
| | Nanosheet | doping | coating | coating | (mol %) | (mol %) | (mol %) | shell |
| | chemical | element | element | element | based on | based on | based on | thickness) |
| | composition | type | type | type | Ti | Ti | Ti | (%) |
| Comparative | — | — | — | — | 0 | 0 | 0 | 0 |
| Example 1 | (unwrapped) | | | | | | | |
| Comparative | | Sr | | | 5 | | | |
| Example 2 | | | | | | | | |
| Comparative | | | | | 10 | | | |
| Example 3 | | | | | | | | |
| Comparative | | | | | 20 | | | |
| Example 4 | | | | | | | | |
| Comparative | Sr₂Nb₃O₁₀ | — | Nb | Sr | 0 | 3 | 2 | 0.3 |
| Example 5 | | | | | | | | |
| Example 1 | | Sr | | | 5 | 3 | 2 | 0.2 |
| Example 2 | | | | | 10 | 1.5 | 1 | 0.1 |
| Example 3 | | | | | 10 | 3 | 2 | 0.2 |
| Example 4 | | | | | 10 | 4.5 | 3 | 0.3 |
| Example 5 | | | | | 20 | 3 | 2 | 0.2 |
| Comparative | Ca₂Nb₃O₁₀ | — | | Ca | 0 | 3 | 2 | 0.3 |
| Example 6 | | | | | | | | |
| Example 6 | | Sr | | | 5 | 3 | 2 | 0.2 |
| Example 7 | | | | | 10 | 3 | 2 | 0.2 |
| Example 8 | | | | | 20 | 3 | 2 | 0.2 |

### Experimental Example 1: Evaluation of Internal Composition of Dielectric Crystal Grains in Multi-Layered Capacitor

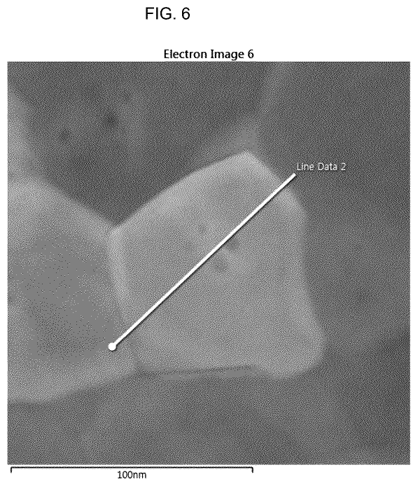

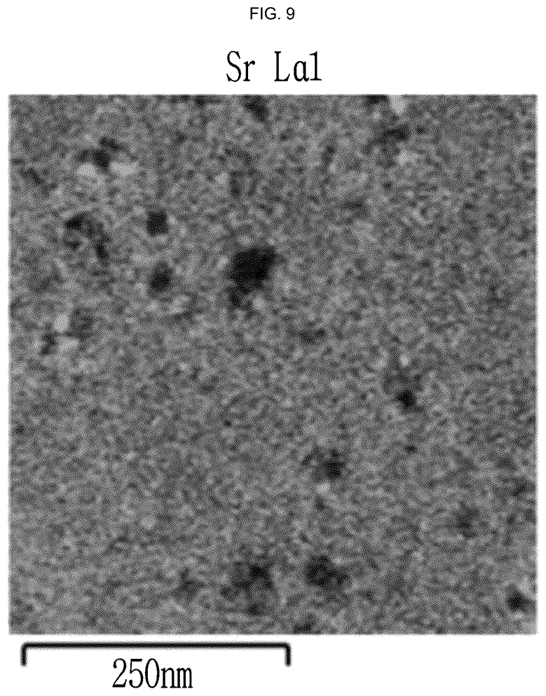

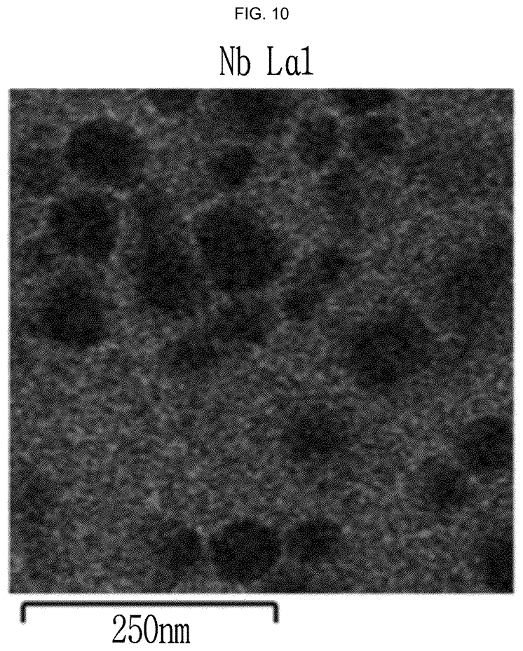

To evaluate the internal composition of the dielectric grains in the multi-layered capacitor prepared according to Example 4, line scan analysis and mapping analysis were performed using TEM-EDX analysis, and the results are shown in FIGS. 6 to 10.

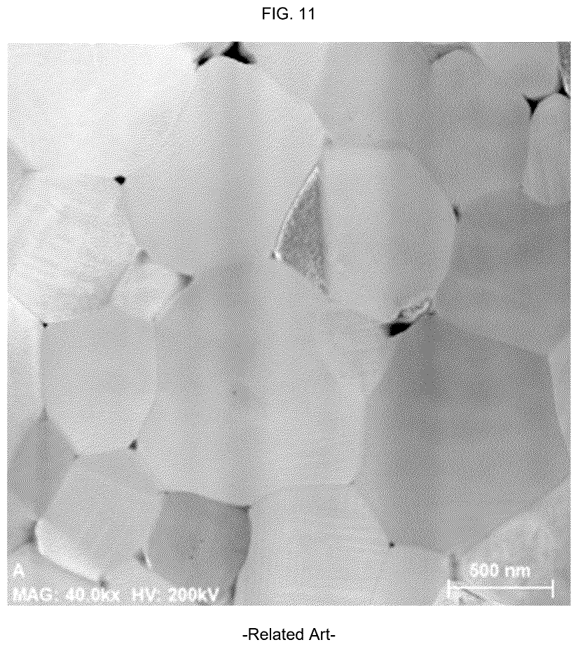

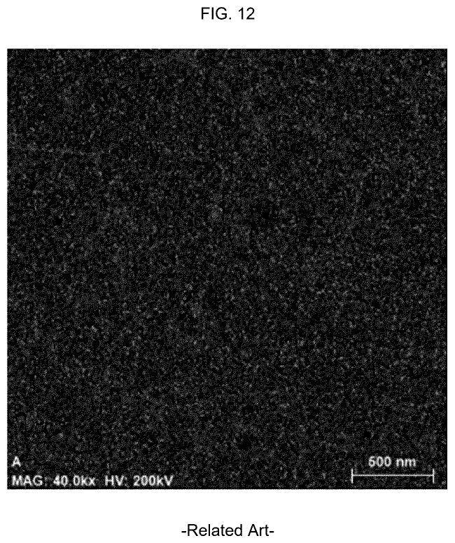

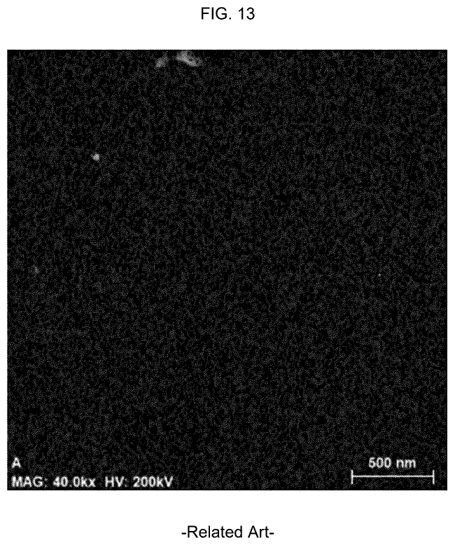

Note that unlike the present Examples in which Nb was introduced through the nanosheet, dielectric crystal grains prepared by mixing BaTiO₃ powder, Nb raw material, and Sr raw material together, followed by heat treatment and doping, as in the related art, were subjected to mapping analysis by using TEM-EDX analysis, and the results are shown in FIGS. 11 to 13.

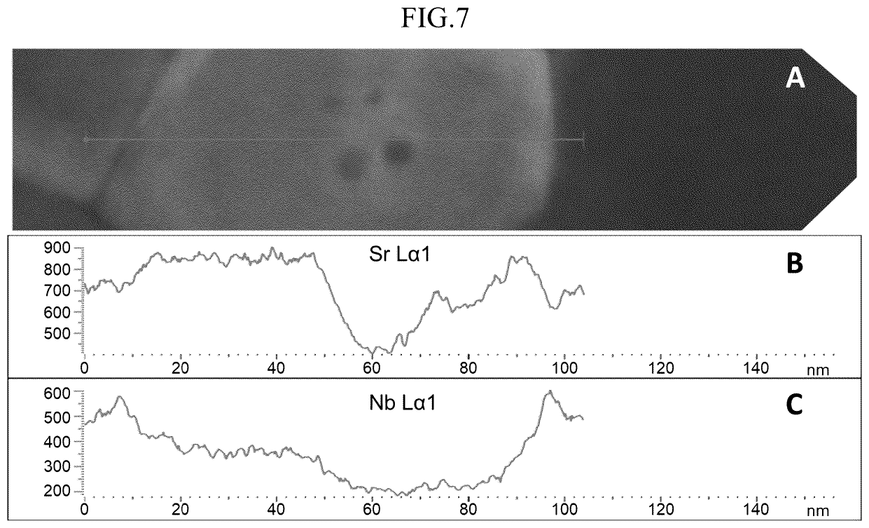

Referring to FIGS. 6 and 7A to 7C, Nb, the first coating element in the dielectric crystal grains of the Example, exhibited the lowest concentration in the region of the core and the highest concentration (maximum peak) in the region of the second shell. In addition, Sr, the first doping element in the dielectric crystal grains of the Example, exhibited the lowest concentration in the region of the core and the highest concentration (maximum peak) in the region of the first shell.

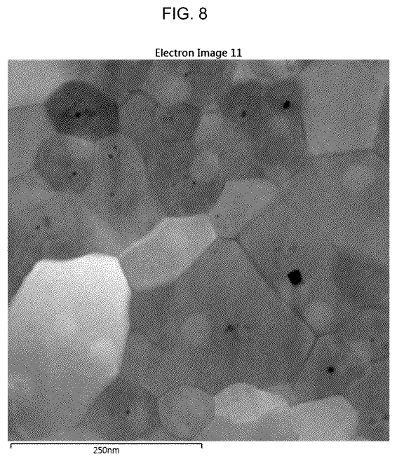

Additionally, referring to FIGS. 8 to 10, it could be confirmed that there were portions where Sr and Nb appeared to be absent in the EDS mapping image as the dielectric crystal grains exhibited the concentration gradient aspect described above.

With this, it could be confirmed that Nb, the first coating element, and Sr, the first doping element, exhibited a significant concentration gradient aspect in the regions of the core, the first shell, and the second shell within the dielectric crystal grains, and that the dielectric crystal grains according to an embodiment of the present disclosure had distinct boundaries for the core, the first shell, and the second shell due to the different compositions of the first coating element or the first dopant element in the respective regions.

On the other hand, referring to FIGS. 11 to 13, it could be confirmed that when Sr and Nb were introduced by doping without applying the nanosheet process, Sr and Nb were evenly dispersed throughout the dielectric crystal grains. With this, it could be confirmed that a multi-shell structure as in the Examples did not appear.

### Experimental Example 2: Evaluation of Temperature Stability of Dielectric Material

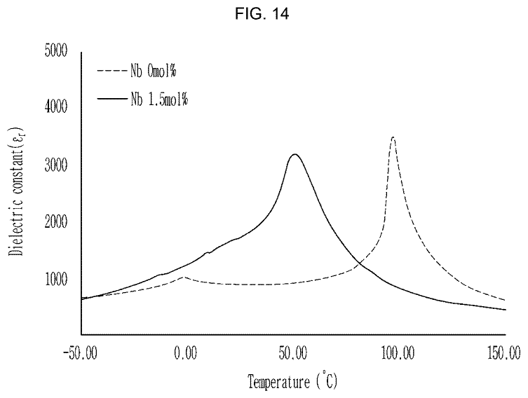

The dielectric characteristics with respect to temperature were evaluated for the dielectric layers in the multi-layered capacitors prepared according to Example 2 and Comparative Example 3, and the results are shown in FIG. 14.

Referring to FIG. 14, in the case of Example 2, it could be confirmed that the degree of change near the peak of the dielectric constant-temperature graph was relatively gradual, indicating excellent temperature stability.

Table 2 below summarizes the results of Experimental Examples 3 and 4 described below.

TABLE 2

| | Average crystal | ε_{RT} (room | Percentage |
|---|---|---|---|
| | grain size | temperature | change (%) in εₘₐₓ |
| | (nm) | dielectric constant) | relative to ε_{RT} |
| Comparative | 1390 | 5200 | 62 |
| Example 1 | | | |
| Comparative | 800 | 1583 | 370 |
| Example 2 | | | |
| Comparative | 930 | 2690 | 230 |
| Example 3 | | | |
| Comparative | 1110 | 3321 | 142 |
| Example 4 | | | |
| Comparative | 500 | 2055 | 1.6 |
| Example 5 | | | |
| Example 1 | 150 | 2770 | 2.8 |
| Example 2 | 180 | 4267 | 86 |
| Example 3 | 90 | 2318 | 17 |
| Example 4 | 80 | 1387 | 13 |
| Example 5 | 80 | 1851 | 39 |
| Comparative | 600 | 2320 | 20 |
| Example 6 | | | |
| Example 6 | 200 | 2050 | 8 |
| Example 7 | 150 | 2000 | 11 |
| Example 8 | 120 | 1960 | 16 |

### Experimental Example 3: Evaluation of Average Crystal Grain Size of Dielectric Material

After the sintered body was prepared using an epoxy mold and polished to reveal the internal cross-section, the average crystal grain sizes of the dielectric crystal grains in the multi-layered capacitors prepared according to the Examples and Comparative Examples were evaluated by measurement with FE-SEM under the conditions of 2 kV to 10 KV and 0.1 nA to 0.2 nA. The results are shown in Table 2 below.

Referring to Table 2, in the case of Examples 1 to 8, it could be confirmed that the average crystal grain size was significantly small as a multi-shell structure was formed by doping Sr and introducing Nb or Ca through 2D nanosheets.

On the other hand, in the case of Comparative Examples 1 to 4 where Nb or Ca was not introduced through 2D nanosheets, it could be confirmed that the average crystal grain size was significantly large, at 800 nm or greater.

In addition, also in the case of Comparative Examples 5 and 6 where Nb or Ca was introduced through 2D nanosheets but Sr was not doped, it could be confirmed that the average crystal grain size was large, at 500 nm or greater.

With this, in the case of the present Examples, it could be confirmed that the effect of reducing the average crystal grain size was very excellent as the multi-shell structure was formed by doping Sr and additionally introducing Nb or Ca through nanosheets.

### Experimental Example 4: Evaluation of Dielectric Constant of Dielectric Material

A double-shell dielectric material was synthesized using the method described in the Examples, and a multi-layered capacitor to which the double-shell dielectric material was applied was prepared. The finished product was heat-treated at 150° C. for 1 hour and aged at room temperature for 2 hours, and TCC was measured to evaluate the dielectric constant of the dielectric material in the multi-layered capacitors prepared according to the Examples and Comparative Examples. The results are shown in Table 2.

Referring to Table 2, when comparing Comparative Examples 1 to 4, in which wrapping (coating) was not applied, with Examples 1 to 5 and Comparative Example 5, which had the same doping composition but introduced the first coating element through wrapping (coating), it could be confirmed that the room temperature dielectric constant decreased, but the percentage change in εₘₐₓ relative to ε_{RT}, which allows for estimation of change in dielectric constant with respect to temperature, was significantly reduced. With this, it could be confirmed that the temperature stability of dielectric constant was improved by applying wrapping (coating).

While the present disclosure has been described in connection with what is presently considered to be practical embodiments, it is to be understood that the disclosure is not limited to the disclosed embodiments. On the contrary, it is intended to cover various modifications and equivalent arrangements included within the spirit and scope of the appended claims.

Therefore, it should be noted that the practical scope of the present disclosure is defined by the appended claims and equivalents thereof.

What is claimed is:

1. A multi-layered capacitor comprising:
a capacitor body comprising a dielectric layer and an internal electrode; and
an external electrode disposed on an outer side of the capacitor body,
wherein the dielectric layer comprises a plurality of dielectric crystal grains, and
wherein the plurality of dielectric crystal grains comprise a core including BaTiO₃, a first shell disposed on the core and including BaTiO₃ doped with a first doping element selected from Sr, Ca, Bi, K, Na, or a combination thereof, and a second shell disposed on the first shell and including a first coating element selected from Nb, Ta, or a combination thereof.

2. The multi-layered capacitor of claim 1, wherein:
when line analysis is performed on the plurality of dielectric crystal grains using transmission electron microscopy-energy dispersive X-ray (TEM-EDX) analysis, a maximum peak of a concentration of the first doping element appears in a region of the first shell, and a maximum peak of a concentration of the first coating element appears in a region of the second shell.

3. The multi-layered capacitor of claim 1, wherein:
when line analysis is performed on the plurality of dielectric crystal grains using TEM-EDX analysis, a lowest value of a concentration of the first doping element appears in a region of the core.

4. The multi-layered capacitor of claim 1, wherein:
when line analysis is performed on the plurality of dielectric crystal grains using TEM-EDX analysis, a lowest value of a concentration of the first coating element appears in a region of the core.

5. The multi-layered capacitor of claim 1, wherein:
a content of the first doping element in the plurality of dielectric crystal grains is 4 to 21 mol % based on a total number of moles of Ti in the plurality of dielectric crystal grains.

6. The multi-layered capacitor of claim 1, wherein:
a content of the first coating element in the plurality of dielectric crystal grains is 1 to 5 mol % based on a total number of moles of Ti in the plurality of dielectric crystal grains.

7. The multi-layered capacitor of claim 1, wherein:
the first shell further includes a second doping element selected from Ti, Hf, Zr, Mg, Nb, Ta, or a combination thereof.

8. The multi-layered capacitor of claim 1, wherein:
the second shell further includes a second coating element selected from Sr, Ca, or a combination thereof.

9. The multi-layered capacitor of claim 8, wherein:
the first doping element includes Sr, and
the first coating element includes Nb.

10. The multi-layered capacitor of claim 1, wherein:
the first shell comprises a compound represented by Chemical Formula 1: 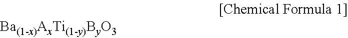
in Chemical Formula 1, A is Sr, Ca, Bi, K, Na, or a combination thereof, B is Ti, Hf, Zr, Mg, Nb, Ta, or a combination thereof, and 0<x≤0.3 and 0≤y≤0.3.

11. The multi-layered capacitor of claim 1, wherein:
the second shell comprises X₂Nb₃O₁₀, X₂Ta₃O₁₀, X₂Nb₂O₇, X₂Ta₂O₇, XBi₂Nb₂O₉, XBi₂Ta₂O₉, or a combination thereof, and X is Sr, Ca, or a combination thereof.

12. The multi-layered capacitor of claim 1, wherein:
an average crystal grain size of the plurality of dielectric crystal grains is 600 nm or less.

13. A method of manufacturing a multi-layered capacitor, the method comprising:
manufacturing a dielectric powder;
manufacturing a dielectric green sheet from the dielectric powder;
forming a conductive paste layer on a surface of the dielectric green sheet;
manufacturing a dielectric green sheet laminate by stacking a plurality of the dielectric green sheets, each of which has the conductive paste layer formed thereon;
firing the dielectric green sheet laminate to manufacture a capacitor body comprising a dielectric layer and an internal electrode; and
forming an external electrode on one surface of the capacitor body,
wherein the dielectric layer comprises a plurality of dielectric crystal grains, and
wherein the plurality of dielectric crystal grains comprise a core including BaTiO₃, a first shell disposed on the core and including BaTiO₃ doped with a first doping element selected from Sr, Ca, Bi, K, Na, or a combination thereof, and a second shell disposed on the first shell and including a first coating element selected from Nb, Ta, or a combination thereof.

14. The method of claim 13, wherein:
the manufacturing of the dielectric powder comprises:
mixing BaTiO₃, a first doping raw material, and a solvent to form a first mixture;
heat-treating the mixture, and then washing and drying the mixture to form BaTiO₃ doped with the first doping element;
forming a nanosheet including a first coating element; and
grinding and mixing the BaTiO₃ doped with the first doping element and the nanosheet to form a dielectric crystal grain,
wherein the first doping raw material is a Sr raw material, a Ca raw material, a Bi raw material, a K raw material, a Na raw material, or a combination thereof.

15. The method of claim 14, wherein:
the forming of the nanosheet comprises:
mixing a first coating raw material and K₂CO₃ to form a second mixture, and then firing the second mixture to form a first intermediate material with a first multilayer structure;
treating the first intermediate material with an acid to form a second intermediate material with a second multilayer structure, wherein the second intermediate material includes hydrogen; and
putting the second intermediate material into a basic solvent, followed by stirring and ultrasonic treatment, to remove hydrogen from the second intermediate material, to exfoliate the second intermediate material, and to form a nanosheet with a single layer structure from which hydrogen has been removed, and
wherein the first coating raw material is a Nb raw material, a Ta raw material, or a combination thereof.

16. The method of claim 15, wherein:
the basic solvent is tetrabutylammonium hydroxide (TBAOH), tetramethylammonium hydroxide (TMAOH), or a combination thereof.

17. The method of claim 14, wherein:
the grinding and mixing include wet grinding and mixing.

18. The method of claim 14, wherein:
a thickness of the nanosheet is 3.5 nm or less.

19. The method of claim 15, wherein:
the firing of the second mixture is performed at 700° C. to 1300° C.

20. The method of claim 15, wherein:
the mixing of the first coating raw material and K₂CO₃ includes mixing a second coating raw material, the first coating raw material, and K₂CO₃, and the second coating raw material is a Sr raw material, a Ca raw material, or a combination thereof.
